(19) United States
(12) Patent Application Publication
(10) Pub. No.: US 2012/0177438 A1
(43) Pub. Date: Jul. 12, 2012

(54) Indexable Coupler for Multi-Band Roller Blinds

(76) Inventors: Philip Ng, Thornhill (CA); Norman Wills, Mississauga (CA)

(21) Appl. No.: 12/985,664

(22) Filed: Jan. 6, 2011

(51) Int. Cl. E06B 9/171

(52) U.S. Cl. 403/293

(57) ABSTRACT

There is provided a coupler for coupling two adjacent roller shade bands, each band having a roller tube. The coupler includes an outer sleeve configured to couple to the roller tube of one of the roller shade bands and an inner sleeve contained within the outer sleeve, the inner sleeve having a coupler element projecting from an axis of the inner sleeve. The coupler can be partially disassembled such that the inner sleeve is movable between a retracted position wherein the inner sleeve is contained within the outer sleeve and a projected position wherein a portion of the inner sleeve projects out of the outer sleeve and away from the roller tube. The inner and outer sleeves are configured such that the inner sleeve can coaxially rotate relative to the outer sleeve when the coupler is disassembled and the inner sleeve is in its projected position. The inner and outer sleeves are further configured such that the inner sleeve cannot rotate relative to the outer sleeve when the inner sleeve is in its retracted position.

### FIELD OF THE INVENTION

The invention relates generally to couplers for coupling two roller tubes together in a multi-band roller blind.

### BACKGROUND OF THE INVENTION

Multi-band roller blinds are quite common in commercial applications as a window covering for large wide windows. In order to facilitate their construction and installation, multi-band roller blinds generally consist of a plurality of separate roller tubes coupled together end to end in a coaxial assembly supported to the window frame or ceiling by a plurality of support brackets, either with or without a head rail. Each of the individual roller tubes in the assembly will have a fabric blind wrapped around it. One of the roller tubes at one end of the assembly will have a control mechanism located at one end, usually adjacent the window frame or wall. The control mechanism will generally be mounted to the wall or window frame by a support bracket of some sort. The control mechanism controls the rotation of the roller blind either by means of a pull chain or an electric motor. One of the roller tubes at the opposite end of the assembly will have an idle end which permits the free rotation of the roller tube on a support bracket of some sort. The roller tubes are coupled to one another in a coaxial fashion by means of a coupler assembly. To ensure that the whole assembly of roller tubes remains horizontally stable, the coupler assemblies coupling adjacent roller tubes together are usually supported by a support bracket mounted to the ceiling or window frame. Since all of the roller tubes are coupled together, engaging the control mechanism causes all of the roller tubes to rotate together simultaneously, thereby lowering or raising the blind in unison.

It will be appreciated that for esthetic reasons, it is important to ensure that the lower end of each roller blind section is horizontally aligned with its neighbor. This requires careful coupling of adjacent roller tubes to ensure that the coupled roller tubes are exactly matched such that the bottom end of each of the blinds rolled on the roller tubes is horizontally aligned. Unfortunately, coupling adjacent roller tubes together is done one at a time as it is impractical to assemble all of the roller tubes together and then lift the entire assembly into place. Therefore, repeated coupling and de-coupling of the roller tubes is required to precisely align the bottom edges of the roller blinds. An improved coupling system which makes it simpler to couple and align adjacent roller tubes in a multi-band roller blind is therefore required.

### SUMMARY OF THE INVENTION

In accordance with one aspect of the present invention, there is provided a coupler for coupling two adjacent roller shade bands, each band having a roller tube. The coupler includes an outer sleeve configured to couple to the roller tube of one of the roller shade bands and an inner sleeve contained within the outer sleeve, the inner sleeve having a coupler element projecting from an axis of the inner sleeve. The inner sleeve is movable between a retracted position wherein the inner sleeve is contained within the outer sleeve and a projected position wherein a portion of the inner sleeve projects out of the outer sleeve and away from the roller tube. The inner and outer sleeves are configured such that the inner sleeve can coaxially rotate relative to the outer sleeve when the inner sleeve is in its projected position. The inner and outer sleeves are further configured such that the inner sleeve cannot rotate relative to the outer sleeve when the inner sleeve is in its retracted position.

With the foregoing in view, and other advantages as will become apparent to those skilled in the art to which this invention relates as this specification proceeds, the invention is herein described by reference to the accompanying drawings forming a part hereof, which includes a description of the preferred typical embodiment of the principles of the present invention.

### DESCRIPTION OF THE DRAWINGS

FIG. 1 is a perspective view of a coupler made in accordance with one aspect of the invention showing the inner sleeve portion of the invention in its projected position.

FIG. 2 is a perspective view of the outer sleeve portion of the coupler shown in FIG. 1.

FIG. 3 is a perspective view of the inner sleeve portion of the coupler shown in FIG. 1.

FIG. 4 is a long sectional view of the coupler made in accordance with one aspect of the invention showing the inner sleeve portion of the invention in its retracted position.

FIG. 5 is an exploded view of the coupler shown in FIG. 1.

FIG. 6 is a front view of a pair of roller bands incorporating the coupler made in accordance with the present invention.

In the drawings like characters of reference indicate corresponding parts in the different figures.

### DETAILED DESCRIPTION OF THE INVENTION

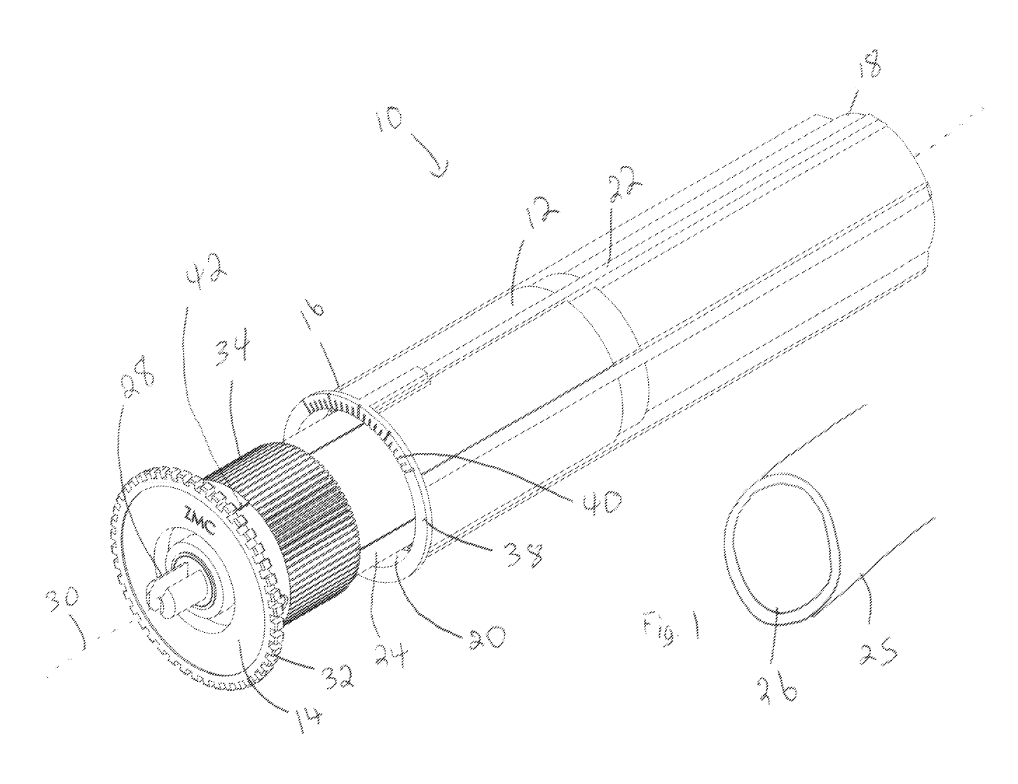

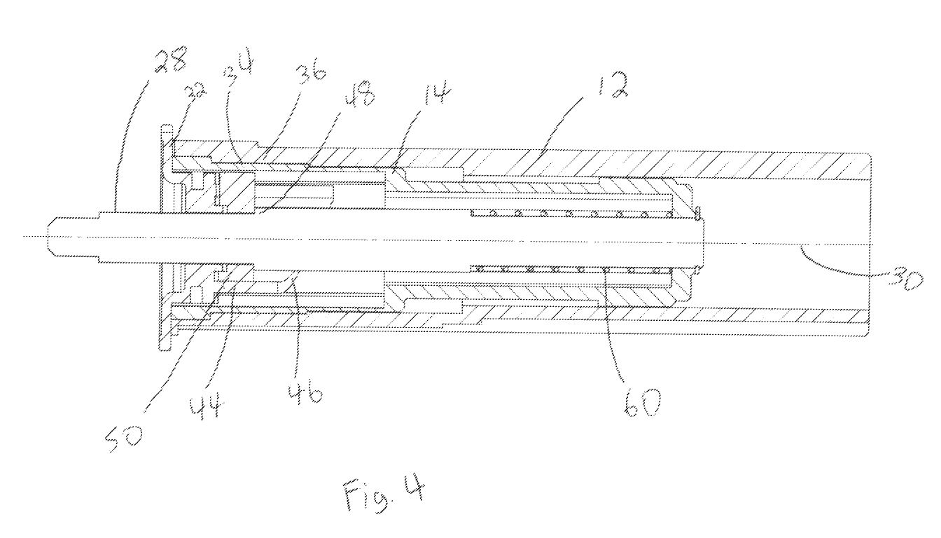

Referring to FIG. 1, a coupler made in accordance with the present invention in shown generally as item 10 and includes outer sleeve 12 and inner sleeve 14. Outer sleeve 12 has opposite ends 16 and 18, inner passage 20 and outer surface 22. Outer surface 22 is dimensioned to fit snuggly within end 26 of roller tube 25. Roller tube 25 forms part of a first roller shade band (not shown) having a roller blind which can be raised or lowered. Inner sleeve 14 has a barrel portion 24 which is configured to be received within inner passage 20 of outer sleeve 16. Inner sleeve 14 also has a coupler element 28 which projects from the inner sleeve and is coaxially aligned with axis 30 which is common to both the inner sleeve and outer sleeve 16 and with roller tube 25. Coupler element 28 is movable between a retracted position, as shown in FIG. 1, and an extended position as shown in FIG. 4. As will be discussed below, inner sleeve 14 has adjustment member (wheel) 32 which is rotatably mounted to the inner sleeve and when rotated causes coupler element 28 to move between its retracted and extended positions.

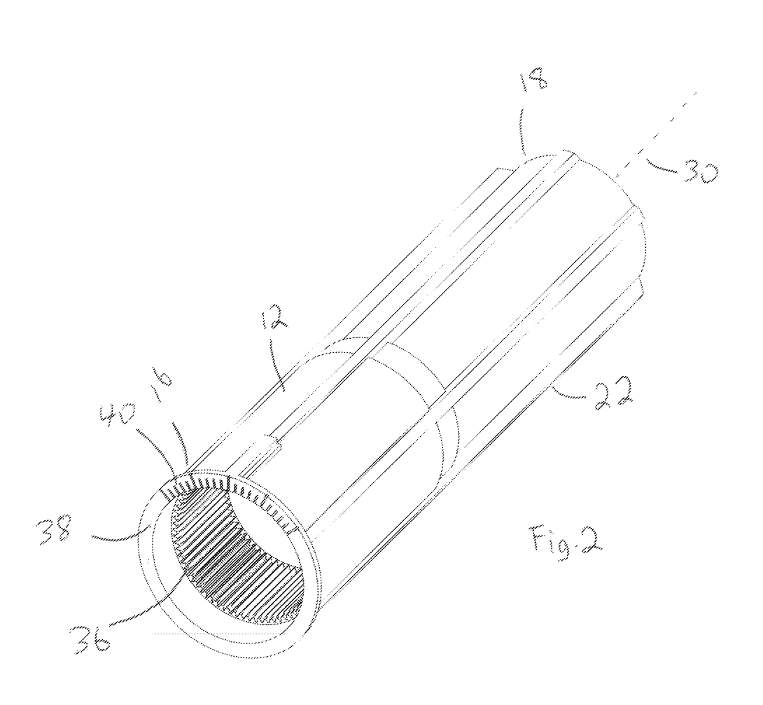

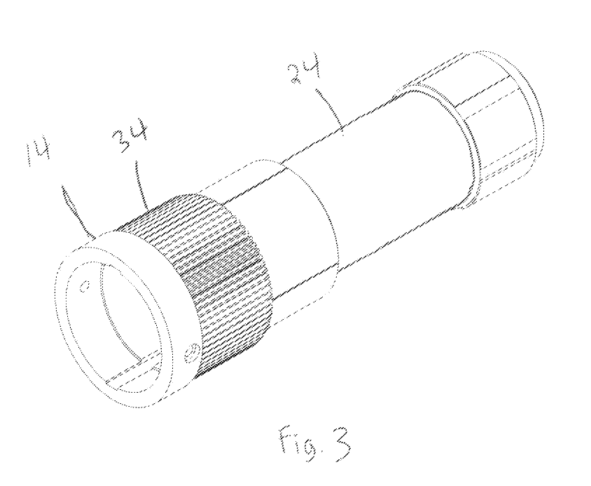

Inner sleeve 14 is movable relative to outer sleeve 12 between a projected position as shown in FIG. 1 wherein the outer sleeve partially disengages from the outer sleeve and is free to rotate relative thereto, and a retracted position as shown in FIG. 4 wherein the inner sleeve is contained within the outer sleeve and the inner sleeve cannot rotate relative to the outer sleeve. Inner sleeve 14 is provided with splined portion 34 having a plurality of ridges or splines which extend parallel to axis 30. As seen in FIG. 2, outer sleeve 12 has splined portion 36 which has a plurality of splines which are likewise parallel to axis 30. Splined portion 34 (see FIGS. 1 and 3) of inner sleeve 14 and splined portion 36 (see FIG. 2) of outer sleeve 12 are dimensioned and configured such that the two splined portions intermesh when inner sleeve 14 is inserted into outer sleeve 12 and the inner sleeve is moved into its retracted position. With the two splined portions intermeshed when the inner sleeve is in its retracted position, the inner sleeve is basically locked in place and cannot rotate relative to the outer sleeve. To rotate the outer sleeve relative to the inner sleeve, the unit must be essentially disassembled by moving the inner sleeve into its extended position by pulling it out from the outer sleeve (see FIG. 1). When the unit is thus partially disassembled, then the two splined portions do not contact and the inner sleeve can be rotated.

Referring again to FIG. 2, outer sleeve 12 has a front face 38 adjacent end 16. Indicia lines 40 are marked on front face 38. As best seen in FIG. 1, indicia 40 can be used to precisely measure the relative rotation of inner sleeve 14 and outer sleeve 12. Inner sleeve 14 can be provided with some indicia 42 such as a coloured spline or ridge which can be aligned with indicia 40 to indicate the exact position of the inner sleeve relative to the outer sleeve when the inner sleeve is inserted into the outer sleeve. In this way, someone assembly a roller blind can set the inner sleeve in a precise rotational angle relative to the outer sleeve, which can be vital in properly aligning roller shade bands (not shown). The two splined portions of the inner and outer sleeve permit the inner and outer sleeve to be locked together in a great variety of angles. The larger the number of splines (i.e. the finer the splines) the greater the number of angles and therefore the finer the adjustment of the angle between the inner and outer sleeves.

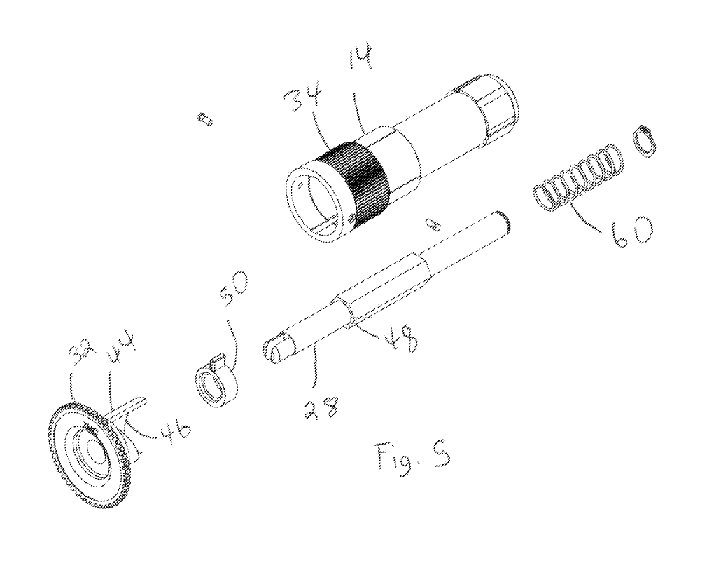

Referring now to FIGS. 4 and 5, coupler element 28 is spring mounted within inner sleeve 14. Adjustment member 32 includes a spiraled barrel portion 44 which has a spiraled ramp 46 formed thereon. Coupler element 28 has a shoulder 48 formed thereon which is configured to abut annular member 50 which is configured to engage one point on ramp 46. Spring 60 biases coupler element 28 towards the coupler element's extended position. Since annular member 50 is positioned between shoulder 48 and ramp 46, rotating adjustment member 32 causes annular member 50 to move which in turn causes coupler 28 to move.

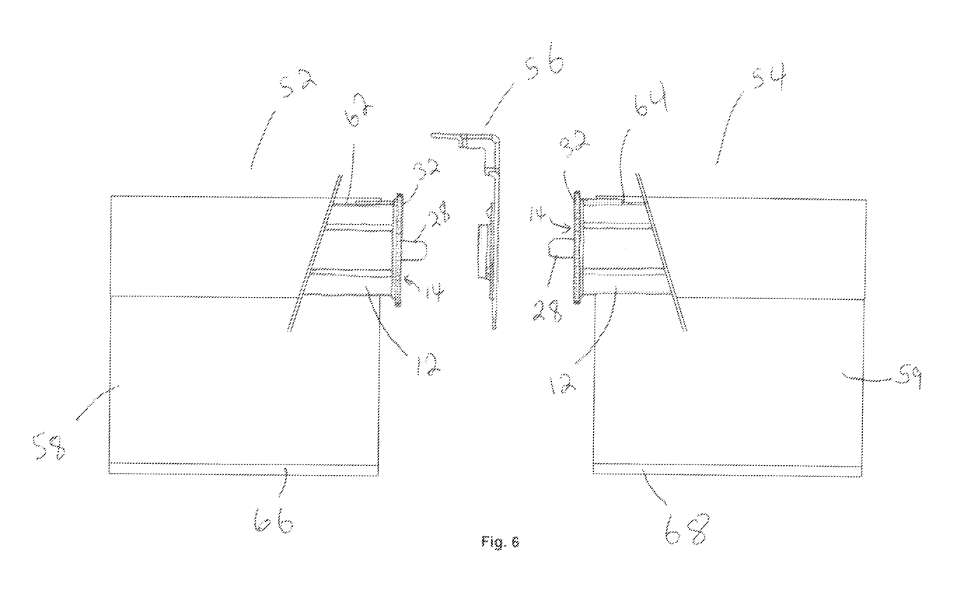

Referring now to FIG. 6, a multi-band roller shade is shown having band portions 52 and 54. Band portions 52 and 54 consist of roller blinds having fabric blinds 58 and 59, respectively, rolled onto roller blind mechanisms 62 and 64, respectively. Roller blind mechanism 62 and 64 are in the form of coupler 10 (see FIG. 1). Each roller blind mechanism 62 and 64 includes coupler 28 and adjustment member 32. Rotating adjustment member 32 causes the corresponding coupler 28 to either retract or protract. Each coupler 28 is configured to couple to the coupler of the adjacent roller blind mechanism, so that the adjacent roller blind bands can be coupled together. Joint coupling support bracket 56 permits the two roller blind bands to be supported together. In order to align bottom bands 66 and 68 to one another, all that is required is that one of the roller blind mechanisms 62 or 64 be adjusted. This requires an operator to adjust the rotational angle between inner sleeve 14 and outer sleeve 12. Since the length of fabric blinds 58 and 59 will be the same, the installer need only adjust the angle of the first blind, then note the relative rotational position of the inner and outer sleeve of the first blind, then simply apply that same rotational position to the second blind and so forth. This enables quick and accurate adjustment of the blinds so that the bottom bars match up when the two blinds are matched together. Also, it is possible to periodically re-adjust the relative setting as a result of the fabric blinds going out of alignment over time.

A specific embodiment of the present invention has been disclosed; however, several variations of the disclosed embodiment could be envisioned as within the scope of this invention. It is to be understood that the present invention is not limited to the embodiments described above, but encompasses any and all embodiments within the scope of the following claims

Therefore, what is claimed is:

1. A coupler for coupling two adjacent roller shade bands, each band having a roller tube, said coupler comprising:
a. an outer sleeve configured to couple to the roller tube of one of the roller shade bands;
b. an inner sleeve contained within the outer sleeve, the inner sleeve having a coupler element projecting from an axis of the inner sleeve;
c. the inner sleeve being movable between a retracted position wherein the inner sleeve is contained within the outer sleeve and a projected position wherein a portion of the inner sleeve projects out of the outer sleeve and away from the roller tube;
d. the inner and outer sleeves being configured such that the inner sleeve can coaxially rotate relative to the outer sleeve when the inner sleeve is in its projected position;
e. the inner and outer sleeves being further configured such that the inner sleeve cannot rotate relative to the outer sleeve when the inner sleeve is in its retracted position.

2. The coupler of claim 1 wherein the inner and outer sleeve have indica which are configured to indicate the relative rotational position of the inner and outer sleeves.

3. The coupler of claim 1 further comprising an adjustment member for moving the coupler between a retracted position wherein the coupler is retracted into the inner sleeve and an extended position wherein the coupler projects away from the inner sleeve.

4. The coupler of claim 1 wherein the coupler is spring biased towards an extended position wherein the coupler projects away from the inner sleeve.

5. The coupler as defined in claim 1 wherein the coupler is configured to coaxially couple to a corresponding coupler element in the adjacent roller shade band.

6. The coupler as defined in claim 1 wherein the inner and outer sleeves have complimentary splines configured to intermesh when the inner sleeve is in its retracted position, the splines being further configured to disengage from each other when the inner sleeve is moved into its projected position.
